(19) United States
(12) Patent Application Publication
(10) Pub. No.: US 2005/0058748 A1
(43) Pub. Date: Mar. 17, 2005

(54) Dairy product with stripes or coating

(76) Inventors: Michel Bourguignon, Lasson (FR); Emmanuel Laine, Caen (FR)

Correspondence Address: WINSTON & STRAWN;PATENT DEPARTMENT, 1400 L STREET, N.W., WASHINGTON, DC, 20005-3502, US

(21) Appl. No.: 10/951,926

(22) Filed: Sep. 27, 2004

Related U.S. Application Data
(63) Continuation of application No. PCT/EP03/03026, filed on Mar. 30, 2003.

(30) Foreign Application Priority Data
Mar. 28, 2002 (EP) 02007101.5

(51) Int. Cl. A23B 4/00

(52) U.S. Cl. 426/130; 426/317

(57) ABSTRACT

The present invention relates to a dairy product that has ornamental patterns mainly based on color effects. The dairy product may have lateral stripes that are preferably visible through a transparent pot or matrix of the dairy product. Different lateral stripes of different colors are possible, and even a complete coating of the dairy product can be achieved.

### CROSS-REFERENCE TO RELATED APPLICATION

This application is a continuation of International application PCT/EP03/03026 filed Mar. 30, 2003, the entire content of which is expressly incorporated herein by reference thereto.

### FIELD OF THE INVENTION

The present invention relates to a dairy product in a pot comprising a dairy and a non-dairy base, as well as to a process for obtaining a dairy product.

### BACKGROUND ART

The art of filling chilled dairy products or also ice-cream in order to obtain a consumable entity, for example a pot, cup or cone, mainly deals with the concern of obtaining a product which is ready for consumption and which at the same time provides an optimal serving size. The filling methods become more and more sophisticated if different alimentary bases are filled at the same time into a single serving and if particular visual aspects are intended or desired.

For example, French patent application FR-2,708,563 discloses a dosing unit which allows simultaneous but independent dosing of different alimentary bases into a single container. In spite of this advantage, this reference is not concerned with visual aspects nor does it disclose how to achieve them.

Visual aspects are an issue, however, in European patent application EP503,254, where an installation for filling of ice cream is arranged together with addition of fruit pulp in a decorative manner. However, the installation is limited in decoration possibilities, mainly because the dosing ducts of the ice cream and the fruity component are not arranged for complete filling of a pot or cup. Thus, improvements in these type products are desired.

### SUMMARY OF THE INVENTION

The present invention relates to a dairy product in a pot or cup, which comprises lateral stripes of a non-dairy component and which thus creates interesting visual aspect, especially if the pot is transparent. These dairy products include variations wherein the non-dairy base may be dosed in a way that also ornamentation of the top or even of the bottom of the dairy product in the pot or cup is achieved. Furthermore, the present invention addresses the problem of totally coating a dairy base by a non-dairy base in order to create interesting and unexpected consumption experiences.

Remarkably, the installation and method of filling dairy and non-dairy bases into a pot or cup was found that provides so far unknown patterns and coatings of dairy bases in such pots or cups. These methods include specific co-extrusion dies, movements of the pot or cup or the co-extrusion die during filling and a dosage timing and speed that, altogether, provide for unique dairy products in pots or cups.

Consequently, in a first aspect the present invention provides a chilled dairy product in a pot or cup and that comprises at least two components, at least one of which is a dairy base, wherein (i) a lateral component is located at least laterally of a main component, and that (ii) the lateral component forms stripes or a complete coating on the main component.

In a second aspect, the present invention provides a process for obtaining the dairy product in a pot according to the invention, which comprises:
lowering a co-extrusion nozzle into a pot or cup, and
lifting the co-extrusion nozzle from the pot while injecting essentially simultaneously at least one lateral and a main component through the co-extrusion nozzle into the pot,
wherein the main component constitutes 60 to 95 wt.-% and the at least one lateral component constitutes 5 to 40 wt.-% of the totally injected components.

### BRIEF DESCRIPTION OF THE DRAWINGS

In the figures, which serve as illustrations of the preferred embodiments of the present invention:

FIG. 1 shows the dairy product (1) according to an embodiment of the present invention, wherein a main component (2) is constituted by a dairy base and the lateral stripes (3) are formed by fruit puree. Furthermore, the product is supplied with a transparent pot (4).

FIGS. 2 A and B shows a nozzle (5) suitable to prepare the product according to the invention. A is a view from lateral exhibiting the central (6) and lateral (7) duct, while B shows the nozzle from below, visualising one central (8) and eight lateral (9) outlet openings for the filling of the different components of the dairy product.

FIG. 3 shows another nozzle (12) suitable to inject a central component into the dairy product according to the invention. The nozzle (10) comprises a central duct (11), an injection nozzle (14), a nozzle support (13), and a product inlet (14).

### DETAILED DESCRIPTION OF THE PREFERRED EMBODIMENTS

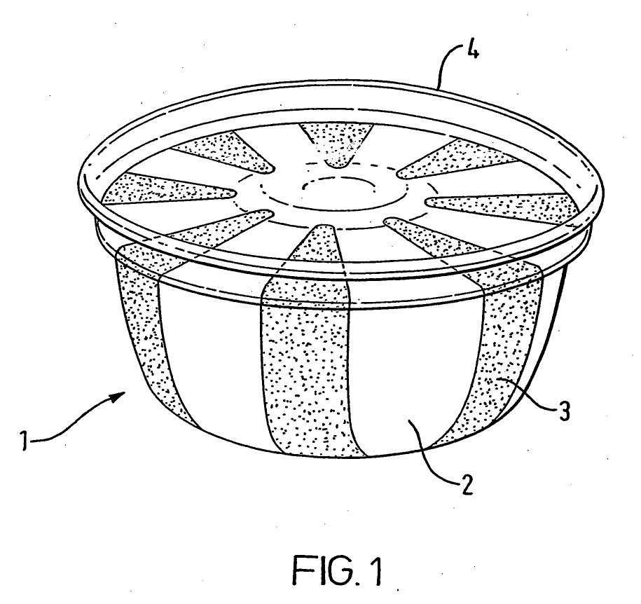

One advantage of the present invention is that it provides novel dairy products as exemplified in FIG. 1. Such dairy products have so far not been produced. Likewise, it is possible to completely coat a dairy base of a dairy product with another component, for example a non-dairy component (fruit pulp, chocolate for example).

Another advantage of the present invention is that it allows lateral ornamentation of dairy bases with non-dairy bases, which creates new visual aspects, such as contrasting stripes or even an entire coating in serving entities ready for consumption.

A further advantage is that the dairy products according to the invention gives a potential consumer an indication or understanding of what flavor or ingredient is in the pot or cup. This is achieved by providing the dairy product in a pot or cup with transparent side-walls exhibiting the stripes of the non-dairy base.

In the context of the present invention, the term non-dairy base encompasses, for example, any colored liquid or semi-liquid food matrix useful for ornamentation. For example, it may be a sauce, such as chocolate or caramel sauce, or a fruit-containing base, such as fruit-puree, fruit pulp, fruit syrup, or a fruit-flavored liquid, semi-liquid or jelly. A non-dairy component, if present, may be selected from the group of the above named bases, and mixtures thereof.

In the context of the present invention, the term “complete coating” refers to a coating that covers either completely the side wall of the dairy product or, in addition, also the top and/or the bottom of the dairy product, depending on the respective embodiment of the invention.

Also, he term “pot” as used herein would include a cup or container which optionally includes a transparent wall or walls and which is often configured as a single serving.

In an embodiment of the dairy product according to the present invention, the lateral component extends from lateral to cover at least partially also the top and/or to the bottom of the main component and thereby also forms stripes, triangles, other forms or a coating on the top and/or the bottom of the main component.

Preferably, other forms are forms that are derived by injecting different amount of the lateral component after the main component has already completely been filled in the pot. The lateral component may form a circle, longish triangles, flower-like shapes, other designs or a coating on the top of the dairy product.

Preferably, the dairy product is a chilled dairy product. That is a dairy product that will, during its shelf life, be kept at 0 to 6° C., preferably about 4° C., and/or that has a relatively low shelf life (up to 2 months, preferably up to 1 month).

Preferably, the dairy product is a bottom-up filled product.

In another embodiment of the present invention the dairy base is yogurt, a flan base or a fresh cheese and/or the other component is a fruit-containing or fruit-flavor containing base.

In a further embodiment, the main component corresponds to a dairy base and at least one lateral component corresponds to a non-dairy base. If present within this embodiment, the central component forming a central core as described below may also be a non-dairy component.

In yet a further embodiment, the two components are of different colors in a way that a visible contrast between the components is present.

In still another embodiment, the pot according to the present invention is transparent to an extent that at least the color of the component laterally on the product is visible to an individual looking from outside at the dairy product.

In addition, the pot may comprise, on its lateral walls, for example, bulges or convexities in the form of stripes or bands. Hence, the lateral component of the dairy product may be situated in the bulges or convexities of the pot, thus further accentuating or distinguishing the presence of the stripes.

For example, the diameter (largest vertical diameter of the pot, usually on the top) and the height of the pot are essentially the same. In another example, the pot is higher than broad (height>diameter). In another embodiment, the pot is broader than it is high (diameter>height).

Preferably, the dairy product according to the invention will cover at least 60% of the surface of the side wall of the pot. Preferably, it will cover at least 70%, more preferably at least 80% of the surface of the side wall of the pot.

In the embodiment wherein the at least one lateral component forms a complete coating of the main component, the surface of the side wall of the pot is totally covered (100%).

Preferably, in the embodiment where lateral stripes are present, the dairy product may have 4 to 10, for example 5 to 8, or 6 to 10 lateral stripes.

In still a further embodiment of the dairy product according to the invention, which consist of at least one central and at least one lateral component, the ratio by weight between the central and the lateral component(s) is in the range from 1:1 to 50:1. Preferably it is between 2:1 to 20:1, more preferably it is between 3:1 to 10:1, and most preferably it is in the range of 4:1 to 7:1.

Preferably, the viscosity of the dairy base (according to Brookfield, spindle 06, 50 rpm at 11° C.), whether it forms the central or a lateral component, is in the range of 5000 to 8500 cPs, preferably in the range of 6000 to 7500 cPs, more preferably 6500 to 7000 cPs.

Preferably, the viscosity of an optional non-dairy base, for example a fruit pulp, if selected as an embodiment of the invention, is in the range of 3500 to 6000 cPs, preferably in the range of 4000 to 5500 cPs, more preferably 4500 to 5000 cPs.

The consistency of the dairy base at 20° C. measured according to Bostwick for 1 minute, may be in the range of 3 to 9, preferably 4 to 7, and for an optional non-dairy base, for example a fruit pulp, if selected as an embodiment of the invention, in the range of 6 to 15, preferably 9 to 11.

The above data allow determining ratios of viscosity and consistency of different components. The ratios indicated below follow the principle that a difference in viscosity between different components may have the advantage that the components do not mix during the shelf life of the dairy product, and that, therefore, sharp contrasts of color between the different components persist during shelf life. It is clarified however, that ratios close or equal to 1 are generally not an obstacle to the working of the present invention.

For example the ratio of the Brookfield viscosities between two different components (for example, a dairy/a non-dairy component) may lie between 0.1 to 20, preferably 0.5 to 15, more preferably between 1 to 10 and most preferably between 1.1 and 2.

For example, the ratio of the Bostwick consistencies between two different components (for example, a dairy/a non-dairy component) may lie between 0.001 to 3, preferably between 0.1 to 2 and more preferably between 0.2 to 1.

In yet a further embodiment, the dairy product according to the present invention further comprises, within the main component, a central component forming a central core of the dairy product.

In an embodiment of the dairy product with a central component, the central component and the lateral component are non-dairy and comprise 20 to 70 wt.-% of the dairy product. Preferably, the central and the lateral component comprise 30 to 60 wt.-%, more preferably 40 to 55 wt.-% of the totally injected components.

In the context of the processes according to the present invention, it is mentioned that a filling of a pot, whereby a nozzle or die is lowered into the pot and food material is filled in during the lifting of the nozzle or die, is generally referred to as a bottom-up filling process.

In an embodiment of the process according to the invention, the at least one main component (optionally including a central component) constitutes 70 to 93 wt.-%, preferably 80 to 90 wt.-% of the totally injected components. Preferably, the process according to the invention provides that the at least one lateral component constitutes 7 to 30 wt.-%, preferably 10 to 20 wt.-% of the totally injected components, for example.

For example, the step of injecting the at least one lateral component may start slightly before the injecting of the main component. In addition, or alternatively, the step of injecting the at least one lateral component is continued after the injecting of the main component has already been completed. The time delays indicated as given above as “slightly before” or “continued” are generally in the range of 0.001 to 1 s, preferably in the range of 0.05 to 0.3 s.

As a possible variation of the process according to the invention, the nozzle may be swirled when it is lifted, to the end that the stripes are sloped or skew with respect to the horizontal of the dairy product.

In the embodiments of the process according to the invention, where a central component forms a central core of the dairy product, the lateral and the central component may constitute 35 to 55 wt.-%, preferably 40 to 50 wt.-% of the total dairy product, and the main component may constitute 65 to 45 wt.-%, preferably 60 to 40 wt.-% of the dairy product.

In order to work the present invention, a suitable filling device may be selected. The filling device preferably comprises a nozzle with several ducts or tubes, which allow for independent but simultaneously controlled filling of different components into a pot. For example, a suitable filling device may comprise a nozzle that is capable of being introduced into a pot and injecting the different components of the dairy product through different ducts while retracting from the pot, for example (bottom-up filling).

Furthermore, the filling device may be capable of controlling independently the following parameters during the filling process: the amount of different components to be filled into a single pot, filling speed, starting time of the filling of a particular component, end time of the filling, opening time and/or size of the nozzle, closing time and/or size of the nozzle. Similarly, the nozzle that may lowered into and retracted from the pot may be controlled: In particular, the distance that the nozzle will be lowered (how deep into the pot), the speed of the penetration, the speed of the retraction.

Furthermore, the nozzle may comprise ducts that are arranged in a way that the visual aspects of the present invention are actually achieved. For example, the nozzle comprises a central duct, surrounded by several lateral ducts. Preferably, the number of the lateral ducts is in the range of 3 to 24, more preferably 4 to 12, even more preferably 6 to 8 ducts. For example, the opening of the central and the lateral ducts is simply a circular hole. Generally, the lateral ducts will be smaller than the central duct, mostly because the lateral component or components, to be filled in by the lateral ducts, are usually present in smaller quantities than the main component.

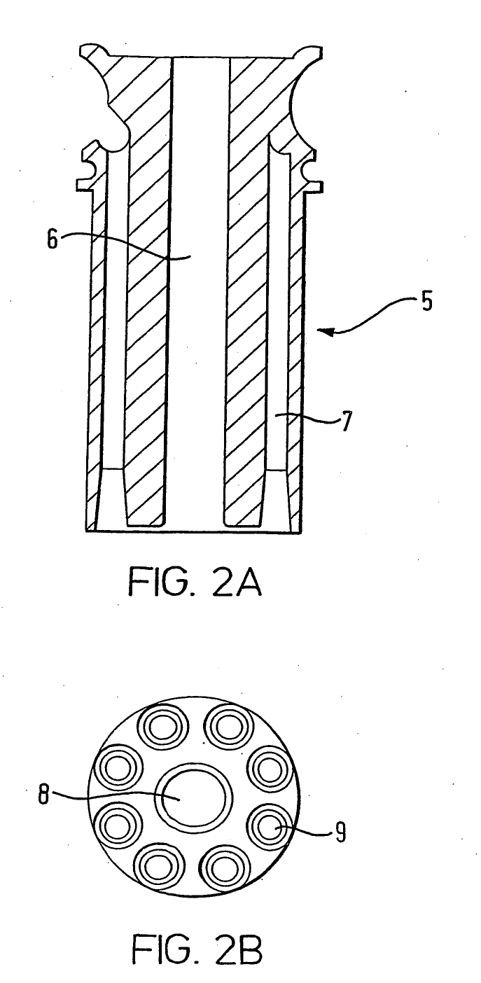

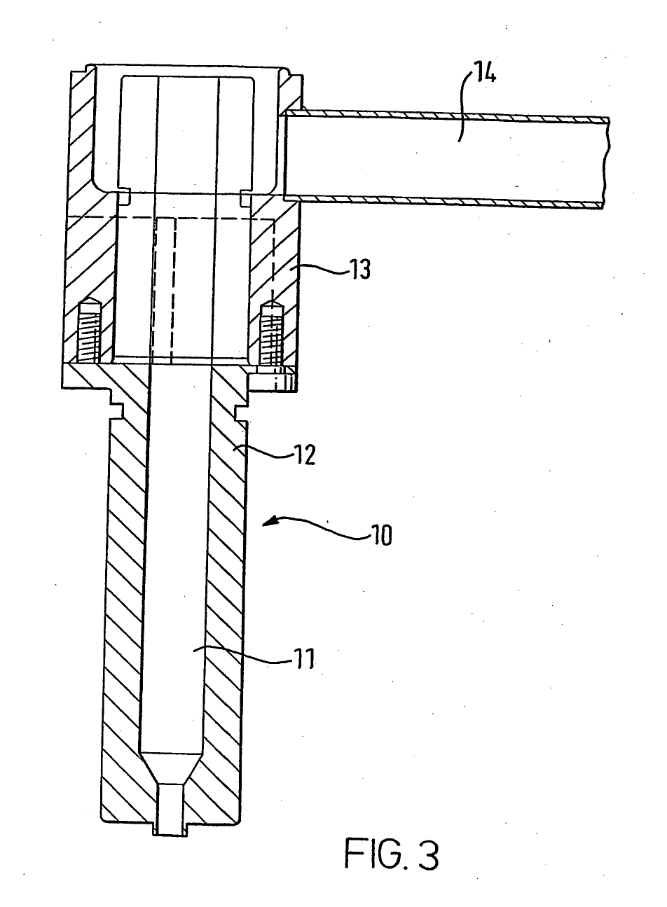

An example of a filling device suitable to prepare the dairy product according to the present invention is disclosed in French patent application FR-2,708,563. FIGS. 2 to 3 of that application in particular show a nozzle that comprises a central duct (33) and eight lateral ducts (36) of a smaller diameter.

The dairy product according to the present invention comprises a pot. Such a pot may be selected to provide an optimal serving size for a dairy product. Hence, a pot may include a volume of 0.3 dl to 1 L. Preferably, it will include a volume of 0.4 dl to 5 dl, more preferably 0.5 dl to 2.5 dl. For example, a pot according to the invention includes a most preferred volume of 0.6 to 2 dl.

Pots, containers, mugs and/or cups according to the invention may be selected from any pot commonly used for chilled dairy products, such as yogurts or fresh cheese, for example. These pots are usually made of polystyrene (PS), polypropylene (PP), polyester (PET) or of glass.

According to a preferred embodiment, the pot according to the invention may be substantially transparent, thus displaying the pattern of colors generated with the different components of the dairy product. In particular, the lateral walls of the pot may be transparent.

Similarly, the pot will not be supplied with a non-transparent label that covers the lateral surface of the pot entirely. Hence, if a label is attached, it will be sufficiently small to exhibit, through the transparent walls of the pot, the colors of stripes and/or coating of the dairy product. Alternatively, in order to visualize the color contrasts in the pot, a transparent label or sticker may be used.

According to the invention, at least one component of the dairy product is a dairy base. The base may be selected from the group of yogurt, flan base, fresh cheese mixtures thereof or ice cream.

For example, two or more components of the dairy product may be dairy bases as those listed above. Visual aspects may then be generated by different colors of the different dairy bases.

Alternatively, at least one component may be a dairy base and another component may be a non-dairy base. The non-dairy base may be selected from the group of fruit pulp, fruit puree, fruit syrup, fruit flavor containing syrups, colored, liquid, semi-liquid or jelly food matrixes and mixtures thereof, for example.

Notably, there is not a strict criterion for the nature of the non-dairy component, but that it preferably has a different color than the mandatory dairy base. While fruit-based or fruit-flavor comprising components are frequently chosen to be combined with dairy bases, this need not necessarily be so. For example, sauces such as chocolate sauce, caramel sauce and so forth are equally suitable.

The present invention relates to all dairy products comprising components wherein at least one component is a dairy base, and at least one component is situated laterally of a main component. In a straightforward approach, a dairy product in this sense may consist of a central dairy base, which forms the main component, and lateral stripes, of fruit pulp, for example. If the dairy product is white and the fruit pulp red, yellow or orange, a product with an appealing visual aspect may be obtained.

This concept may be further developed by two non-dairy components (fruit pulps, for example) that form different lateral stripes and a dairy base, which forms the main component. In so doing, a dairy product with a dairy core and lateral stripes of different colors may be obtained. For example, fruit pulp of strawberries and apricots may be selected to form lateral stripes in red and orange or yellow color, respectively.

Alternatively, two dairy bases may be used, wherein one dairy base will form the lateral component (lateral stripes) and another dairy base will form the main component. Likewise, two dairy bases may be combined with a non-dairy base, wherein the two dairy bases form lateral stripes and the non-dairy base forms a central component.

If two (or more) lateral components are used, they may be arranged in alternating colors. In the embodiment, where the main component is totally coated by the lateral component, and if a transparent pot, it is thus possible that, from lateral, only the different colors of alternating lateral components are visible, while the main component, for example a dairy base, is completely hidden.

It is possible, furthermore, that the main component itself comprises an additional core (for example, a central component). For example, if the main component is the dairy base and the lateral component is constituted of fruit pulp or chocolate, it is also possible to further introduce fruit pulp or chocolate forming a central component.

The central component may extend vertically in the center of the pot from the bottom to the top, for example, within a dairy base. The central component may also have a ball-like form within the main component. The central component may be visible from the top of the dairy product, forming a circle that remains after injection of the central component. In the embodiment wherein a central component (central core) is injected into the main component, the central component may be a dairy or a non-dairy base as given above. Preferably, the central component is a non-dairy base. For example, the lateral component and the central component may be the same or different non-dairy bases as mentioned above. For example, the lateral and the central component may be different or the same fruit puree.

In conclusion, all sorts of variations may be conceived in the combination of only dairy components and/or dairy and non-dairy components. In addition, the stripes that are located laterally and that are constituted by the lateral component need not necessarily extend totally vertically from the bottom to the top. The stripes may form s-shaped lines, sloping lines or even interrupted (dashed) or zigzag lines. These forms may be obtained by turning accordingly the pot and/or the nozzle during the filling process.

For example, if a dairy product in a pot of 60 to 200 ml is produced with 6 to 8 lateral, vertically extending stripes consisting of fruit pulp and a main component consisting of a dairy base is to be manufactured, one may proceed as follows:

A filling device as disclosed in French patent application FR-2,708,563 (manufactured by ERCA, France) is used, which comprises a nozzle with one central and 6 to 8 lateral ducts. The lateral component may be inserted via 6 to 8 relatively smaller lateral ducts of the nozzle, while the central dairy base may be inserted via a relatively larger central duct. The two components are stored, prior to insertion, in two separate containers.

The filling volume of the main component (a dairy base, for example) per pot may be adjusted to the size of the pot. In an 80 ml pot, for example, the main component may comprise 40 to 75 cm³, preferably 50 to 60 cm³.

In a 200 ml pot, for example, the main component may comprise 100 to 180 cm³, preferably 130 to 150 cm³.

The filling volume of the lateral component (a non-dairy base such as fruit pulp, for example), in a 80 ml pot, for example, may be adjusted to 5 to 40 cm³, preferably 10 to 30 cm³, more preferably 8 to 20 cm³.

The speed of injection of the main component may be adjusted to 1,000 to 45,000 imp/s (impulses per second, 46,080 imp/s correspond to 2,700 rpm [rounds per minute]), preferably 10,000 to 40,000 imp/s, more preferably 15,000 to 30,000 imp/s. This speed depends on the relative amount of the filling volume of the main component to the lateral component and on the product characteristic.

The speed of injection of the lateral component may be adjusted to 500 to 20,000 imp/s, preferably 1,000 to 8,000 imp/s, more preferably 3,000 to 5,000 imp/s.

If it is intended to have the lateral stripes extending to the top of the dairy product, it is further recommended to start with the filling of the fruit pulp a little bit later. Hence, the time delay of the filling of the lateral with respect to the main component may amount to up to 1 s, preferably 0.05 to 0.5 s, more preferably 0.07 to 0.2 s. Alternatively, the lateral component may be started with, the main component being delayed. In this later case, the stripes will extend to the bottom of the dairy product.

It may also be wished that the lateral component extends to the bottom and to the top of the dairy product. In this case, the lateral component is started to be filled a little earlier and the parameters and/or amounts of components are chosen in a way that the filling machine still is about to fill the lateral component, while the main component has already completely been filled into the pot.

As an advancement of the lateral component extending to the bottom and to the top, also a complete coating of the main component by the lateral component may be achieved. This may be done, for example, by using a nozzle with additional lateral ducts, for example 6 to 24, preferably 8 to 16 lateral ducts. In so doing, neighboring stripes will merge during the filling process and form a complete coating. Alternatively or simultaneously, a complete coating may be achieved by using higher amounts of the lateral component and by adjusting the filling parameters. Generally, the same time intervals with respect to delayed and/or early filling as indicated above should be sufficient to achieve a complete coating.

Hence, if the filling of the pot is started with the lateral component, the main component is therefore arriving in the pot slightly delayed. Further, the filling process is ended with the lateral component, that is, the main component must already have been filled when the lateral component is still being filled.

Further parameters to be adjusted are the course of the nozzle, that is the distance and the speed at which the nozzle is lowered and lifted during the filling process of course, these are strongly variable parameters, that depend on the filling volume, and further on the shape and the length of the pot.

For example, resuming the filling of a dairy product in a pot of 60 to 200 ml comprising 6 to 8 lateral stripes, the total lowering and lifting distance may be adjusted to 1 to 10 cm, preferably 2 to 7 cm, more preferably 3 to 6 cm.

The speed of lifting the nozzle during the filling procedure may be adjusted to 1,000 to 45,000 imp/s, preferably 1,000 to 10,000 imp/s, more preferably 2,000 to 5,000 imp/s.

Dairy products with more (up to 24, for example) or less (2 to 4, for example) stripes are manufactured according to the above principles, including variations in the number of lateral ducts of the nozzle of the filling device. The skilled person is able to perform these variations.

It is of utmost importance to note that all of the above-indicated ranges are ranges that may be substantially modified while still obtaining a product according to the invention. This is so, because different parameters may outbalance other parameters. For example, the injecting speed of any component may be slowed down remarkably, if at the same time the lifting speed of the nozzle is reduced.

Similarly, the time-delay of the start of the filling, if any, may be substantially increased, if the injecting speed is generally slowed down. Inverse arguments hold true if the overall speed is increased; in this case the time-delay may be reduced substantially.

As another example, if stripes extending to the top of the product are desired, this may not only be achieved by delaying the start of the filling of the lateral component, but also by just adding a higher amount of the lateral component. In this case, at the moment the main component is already filled, there still will be material of the lateral component to be filled. A similar result is achieved if the speed of injection of the lateral component is just slowed down. Also in this later case, a delayed starting of filling may prove to be not necessary to obtain stripes that extend to the top of the product.

In embodiments wherein a central component is present, the nozzle (12) of FIG. 4 may be used. The nozzle (12) is simply placed directly above the dairy product comprising stripes or a complete coating. Then the central component is injected, from above, into the dairy product. In a pot of 90 cm³, for example, about 20 to 40 cm³ of the central component may be injected. For example, the central component may amount to 20 to 40 wt.-%, preferably 25 to 35 wt.-% of the entire dairy product. The injection speed may be in the range of 20,000 to 50,000 imp/s, preferably 35,000 to 42,000 imp/s.

If the central component is a non-dairy base, for example a fruit puree or pulp, it preferably does not comprises fruit pieces that have a diameter>1 cm in, preferably not >0.5 cm, in order to allow for injection by a relatively narrow nozzle (0.3 to 1 cm, for example).

### EXAMPLES

The following examples are given by way of illustration only and in no way should be construed as limiting the subject matter of the present application.

### Example 1

### Preparation of a Dairy Product with Stripes

A dairy product of 170 g comprising a dairy base like a fresh cheese (150 g), which forms a main component, and puree of strawberry (20 g) forming 8 lateral stripes extending to the top of the product is produced (FIG. 1).

The filling device is purchased from ERCA, France and corresponds to the device disclosed in French patent application FR-2,708,563. The nozzle used for the filling of a transparent pot is given in FIG. 3.

The filling parameters for the filling per individual pot are given, for each component, in Table 1 below:

TABLE 1
Filling and product parameters of a dairy product with stripes.

| | Puree of | |
|---|---|---|
| | strawberry | Dairy base |
| Filling weight per pot (g) | 20 | 150 |
| Speed of injection (Imp/s) | 20,000 | 15,000 |
| Speed or refilling of the | 10,000 | 10,000 |
| dosing units (Imp/s) | | |
| Start time of filling (s) | 0 | 0.1 |

The ratio of the Brookfield-viscosity (dairy base/puree of fruit) is 1.4, and the ratio of the Bostwick-consistency of the two components is 0.5.

### Example 2

### Preparation of a Coated Dairy Product

A dairy product of 150 g comprising a dairy like a fresh cheese (110 g), which forms a main component, and puree of strawberry (40 g) forming a complete coating of the dairy base is produced.

The same filling device as indicated in Example 1 is used, whereby the nozzle is exchanged with a nozzle comprising 20 lateral ducts and openings.

The filling parameters for the filling per individual pot are given, for each component, in Table 2 below:

TABLE 2
Filling and product parameters of a coated dairy product.

| | Puree of strawberry | Dairy base |
|---|---|---|
| Filling weight per pot (g) | 40 | 110 |
| Speed of injection (Imp/s) | 10,000 | 15,000 |
| Speed or refilling of the dosing | 10,000 | 10,000 |
| units (Imp/s) | | |
| Start time of filling (s) | 0 | 0.15 |

### Example 3

### Dairy Product Comprising Stripes and a Central Core

The product of Example 1 is further processed by injecting a central component forming a central core.

Hence, the product of Example 1 is transferred below a special nozzle having an injection diameter of 0.5 cm (see FIG. 3). The nozzle is lowered onto the center of the dairy main component and 50 g of strawberry puree is injected into the product at a speed of 40,000 imp/s.

As a result, a dairy product is obtained, comprising a dairy base covered laterally and by vertical stripes and comprising, as a central component, a central core of fruit puree.

1. A dairy product in a pot comprising at least two components, one of which is a main component and another of which is a lateral component, with at least one of the components being a dairy base, wherein (i) the at least one component that is a lateral component is located laterally of the main component, and that (ii) the lateral component forms stripes or a complete coating on the main component.

2. The dairy product according to claim 1, wherein the lateral component extends to cover at least partially upper or lower portions of the main component and thereby also forms stripes, triangles, other forms or a coating on the upper or lower portions of the main component.

3. The dairy product according to claim 1, wherein the dairy base is yogurt, a flan, or a cheese and the other component is a fruit-containing or fruit-flavor containing base.

4. The dairy product according to claim 1, wherein the main component is the dairy base and at least one lateral component is a non-dairy base.

5. The dairy product according to claim 1, wherein the two components are of different colors in a way that a visible contrast between the components is present.

6. The dairy product according to claim 1, wherein the pot is transparent to an extent that at least the color of the component laterally on the product is visible to an individual looking from outside at the dairy product.

7. The dairy product according to claim 1, wherein the dairy and non-dairy base are present in a weight ratio in the range of 1:1 to 50:1.

8. The dairy product according to claim 1, further comprising, within the main component, a central component, forming a central core of the dairy product.

9. The dairy product according to claim 8, wherein the central component and the lateral component are non-dairy components and comprise 20 to 70 wt.-% of the dairy product.

10. The dairy product according to claim 1, which has 4 to 10 lateral stripes.

11. A process for obtaining a dairy product in a pot, which comprises: lowering a co-extrusion nozzle into a pot, lifting the co-extrusion nozzle from the pot while at essentially simultaneously injecting at least one lateral component and at least one main component through the co-extrusion nozzle into the pot, to provide the at least one component as a lateral component that is located laterally of the main component, so that the lateral component forms stripes or a complete coating on the main component.

12. The process according to claim 11, wherein the main component constitutes 60 to 95 wt.-% and the at least one lateral component constitutes 5 to 40 wt.-% of the totally injected components in the pot.

13. The process according to claim 11, which further comprises injecting, into the main component, a central component forming a central core of the dairy product.

14. The process according to claim 11, wherein the main component is the dairy base and at least one lateral component is a non-dairy base.

15. The process according to claim 11, wherein the two components are of different colors in a way that a visible contrast between the components is present.

16. The process according to claim 1, wherein the pot is transparent to an extent that at least the color of the component laterally on the product is visible to an individual looking from outside at the dairy product.

17. The process according to claim 11, wherein the components form 4 to 10 lateral stripes in the product.
